(19) United States
(12) Patent Application Publication
(10) Pub. No.: US 2026/0050157 A1
(43) Pub. Date: Feb. 19, 2026

(54) METHOD FOR DESIGNING METASURFACE ELEMENT, AND PROJECTION DEVICE

(71) Applicant: Sunny Omnilight Technology Co.,Ltd., Yuyao (CN)

(72) Inventors: Keqi MA, Yuyao, (CN); Qiang SONG, Yuyao (CN); Yuan CHEN, Yuyao (CN)

(73) Assignee: Sunny Omnilight Technology Co.,Ltd., Yuyao (CN)

(21) Appl. No.: 19/020,774

(22) Filed: Jan. 14, 2025

(30) Foreign Application Priority Data
Aug. 14, 2024 (CN) 202411116633.9

(51) Int. Cl. G02B 27/00; G02B 1/00

(52) U.S. Cl. CPC G02B 27/0012; G02B 1/002

(57) ABSTRACT

A method for designing a metasurface element, and a projection device are provided. The method for designing a metasurface element includes: determining a collimated phase φ_{collimator} of a metasurface element and a diffractive phase φ_{DOE} of the metasurface element according to a target projection dot matrix, obtaining one of a phase φₚ when the metasurface element enters through p-polarized light and a phase φₛ when the metasurface element enters through s-polarized light according to the collimated phase φ_{collimator} and the diffractive phase φ_{DOE}, and determining the other one of the phase φₚ and the phase φₛ according to a target projection light-homogenizing light field; and determining distribution of a plurality of nano structures of the metasurface element according to the phase φₚ and the phase φₛ.

### CROSS-REFERENCE TO RELATED APPLICATION(S)

The disclosure claims the priority to Chinese Patent Application No. 202411116633.9 filed with the Chinese Patent Office on Aug. 14, 2024, which is incorporated herein in its entirety by reference.

### FIELD

The disclosure relates to the technical field of optical projection devices, and particularly, to a method for designing a metasurface element, and a projection device.

### BACKGROUND

The 3D imaging technology includes 3D structured light, time of flight, binocular stereo imaging, etc. The 3D structured light generally uses a Diffractive Optical Element (DOE) to project a dot matrix. An existing projection device needs to collimate light emitted by a light source by using a collimator, and then reproduce the light for projection by a diffractive optical element, resulting in a large overall size. The iTof in the time of flight generally needs to project a homogeneous light field, which is often implemented by using a diffuser composed of microlens arrays. However, for an application scenario with a large field of view, there is a large difficulty in machining a surface shape of a corresponding microlens, leading to a poor light-homogenizing effect.

A metasurface element is an emerging optical element that has flourished in recent years. The metasurface element includes a subwavelength structure in two-dimensional arrangement, which may control an electromagnetic wave with multi-dimensional freedom, such as amplitudes, phases, and polarization. By using the polarization control capability of the metasurface element, two projected light field effects may be theoretically integrated in one device. However, due to distribution of different projected light fields, it is more difficult to design the metasurface element, causing integration to be relatively difficult.

That is to say, there is a problem in the related art that it is difficult to integrate a plurality of projected light fields on a metasurface element.

### SUMMARY

Some embodiments of the disclosure provide a method for designing a metasurface element, and a projection device, so as to solve the problem in the related art that it is difficult to integrate a plurality of projected light fields on a metasurface element.

In an embodiment of the disclosure, a method for designing a metasurface element is provided. The method includes: a collimated phase φ_{collimator} of a metasurface element and a diffractive phase φ_{DOE} of the metasurface element are determined according to a target projection dot matrix, one of a phase φₚ when the metasurface element enters through p-polarized light and a phase φₛ when the metasurface element enters through s-polarized light are obtained according to the collimated phase φ_{collimator} and the diffractive phase φ_{DOE}, and the other one of the phase φₚ and the phase ₛ is determined according to a target projection light-homogenizing light field; and a distribution of a plurality of nano structures of the metasurface element is determined according to the phase φₚ and the phase φₛ.

In an embodiment, determining the collimated phase φ_{collimator} of the metasurface element according to the target projection dot matrix includes: the target projection dot matrix is set to include N×N sub dot matrices, where N≥1.

$${φ}_{collimator} = \frac{2 π}{λ} {\sum }_{i = 1}^{N} {a}_{i} {r}^{2 i} + {φ}_{0} .$$

λ is a working wavelength of the metasurface element, aᵢ is a phase coefficient, r is a distance between the plurality of nano structures of the metasurface element and a central position of the metasurface element, and φ₀ is a constant.

In an embodiment, determining the collimated phase φ_{collimator} of the metasurface element according to the target projection dot matrix includes: the target projection dot matrix is set to include N×N sub dot matrices, where N≥1.

$${φ}_{collimator} = \frac{2 π}{λ} ( f - \sqrt{{r}^{2} + {f}^{2}} ) + {φ}_{0} .$$

λ is a working wavelength of the metasurface element, r is a distance between the plurality of nano structures of the metasurface element and a central position of the metasurface element, φ₀ is a constant, and f is a working focal length of the metasurface element.

In an embodiment, the working focal length f of the metasurface element meets:

$$f = \sqrt{\frac{{{W}^{2} ( N - 1 )}^{2}}{16 sin \frac{FOI}{2}} - \frac{{W}^{2}}{4}} .$$

W is a size of a light source chip, and FOI is a field of illumination of the target projection dot matrix.

In an embodiment, determining the diffractive phase φ_{DOE} of the metasurface element according to the target projection dot matrix includes: the diffractive phase φ_{DOE} of the metasurface element is generated by using an iterative Fourier algorithm according to the target projection dot matrix.

In an embodiment, obtaining one of the phase φₚ when the metasurface element enters through the p-polarized light and the phase φₛ when the metasurface element enters through the s-polarized light according to the collimated phase φ_{collimator} and the diffractive phase φ_{DOE} includes: the phase φₚ is obtained according to the collimated phase φ_{collimator} and the diffractive phase φ_{DOE}, where φₚ=mod(φ_{collimator}+φ_{DOE},2π).

In an embodiment, determining the other one of the phase φₚ and the phase φₛ according to the target projection light-homogenizing light field includes: a light-homogenizing phase φ_{diffuser} of the metasurface element is generated by using an iterative Fourier algorithm according to the target projection dot matrix, and according to the light-homogenizing phase φ_{diffuser}, the phase φₛ when the metasurface element enters through the s-polarized light is obtained, where φₛ=mod(φ_{diffuser},2π).

In an embodiment, before determining the distribution of the plurality of nano structures of the metasurface element according to the phase φₚ and the phase ₛ, the method for designing a metasurface element further includes: a relationship diagram between a size of an initial nano structure and a phase of the initial nano structure is established, and distribution of a plurality of initial nano structures meeting the phase φₚ and the phase φₛ is searched from the relationship diagram.

In an embodiment, searching the distribution of the plurality of initial nano structures meeting the phase φₚ and the phase φₛ from the relationship diagram includes: absolute values of errors between the phase of the initial nano structure in the relationship diagram and the phase φₚ, and between the phase of the initial nano structure in the relationship diagram and the phase φₛ are calculated, and the initial nano structure in which the absolute values of the errors meet a preset error and a light transmittance rate is greater than or equal to a preset light transmittance rate is selected.

In an embodiment, establishing the relationship diagram between the size of an initial nano structure and the phase of the initial nano structure includes: a shape of the initial nano structure is preset; initial nano structures with different sizes are scanned according to the shape of the initial nano structure, so as to obtain phase responses of the initial nano structures with the same shapes and different sizes to the s-polarized light and the p-polarized light; and the relationship diagram between the size of the initial nano structure and the phase of the initial nano structure is established.

In an embodiment, presetting the shape of the initial nano structure includes: the initial nano structure is designed as a columnar non-rotationally symmetric structure, and a cross section of the initial nano structure in a direction parallel to a substrate is an oval or a polygon.

In an embodiment, before or after presetting the shape of the initial nano structure includes: a material of the initial nano structure is determined according to the working wavelength of the metasurface element, where the material of the initial nano structure includes one of Si, aSi, TiO₂, GaN, and HfO₂.

In an embodiment, a height of the nano structure is set to be within a range greater than or equal to 400 nm and less than or equal to 800 nm; and/or a distance between adjacent nano structures among the plurality of nano structures is set to be greater than or equal to 100 nm and less than or equal to 700 nm; and/or the plurality of nano structures are arranged in an array.

In another embodiment of the disclosure, a projection device is provided, including: a light source, configured to emit light in different polarization states, where the light source includes a plurality of light-emitting dots; and a metasurface element, obtained by the above method for designing a metasurface element. The metasurface element includes a substrate and a plurality of nano structures arranged on the substrate. The plurality of nano structures are columnar non-rotationally symmetric structures. A phase of the metasurface element includes various functional phases such that the metasurface element projects a dot matrix to lights in one polarization state and projects a light-homogenizing light field to lights in the other polarization state.

Through the technical solution of some embodiments of the disclosure, the method for designing a metasurface element includes: the collimated phase φ_{collimator} of the metasurface element and the diffractive phase φ_{DOE} of the metasurface element are determined according to the target projection dot matrix, one of the phase φₚ when the metasurface element enters through the p-polarized light and the phase φₛ when the metasurface element enters through the s-polarized light are obtained according to the collimated phase φ_{collimator} and the diffractive phase φ_{DOE}, and the other one of the phase φₚ and the phase φₛ is determined according to the target projection light-homogenizing light field; and the distribution of the plurality of nano structures of the metasurface element is determined according to the phase φₚ and the phase φₛ.

The collimated phase φ_{collimator} and the diffractive phase φ_{DOE} are determined according to the required target projection dot matrix; then one of the phase φₚ when the metasurface element enters through the p-polarized light and the phase φₛ when the metasurface element enters through the s-polarized light are obtained according to the collimated phase φ_{collimator} and the diffractive phase φ_{DOE}; the other one of the phase φₚ and the phase φₛ is determined according to the required target projection light-homogenizing light field; and finally, the distribution of the plurality of nano structures of the metasurface element is determined according to the phase φₚ and the phase φₛ, causing the distribution of the plurality of nano structures of the metasurface element to meet the phase φₚ and the phase φₛ at the same time, such that the metasurface element may receive the p-polarized light and the s-polarized light and project a dot matrix light field and a light-homogenizing light field, thereby realizing a projected light field in the form of a dot matrix and a projected light field of the light-homogenizing light field. By designing the metasurface element rationally, the metasurface element may realize different projected light fields for different polarized light, such that the metasurface element integrates effects of the plurality of projected light fields, thereby ensuring the diversity and scope of application of projection.

### BRIEF DESCRIPTION OF DRAWINGS

The drawings, which form a part of the present application, are used to provide a In an embodiment understanding of the disclosure. The exemplary embodiments of the disclosure and the description thereof are used to explain the disclosure, but do not constitute improper limitations to the disclosure. In the drawings:

FIG. 1 is a schematic structural diagram of a nano structure of a metasurface element according to an embodiment of the disclosure.

FIG. 2 is a schematic distribution diagram of light-emitting dots of a light source according to an embodiment of the disclosure.

FIG. 3 is a distribution diagram of a collimated phase φ_{collimator} and a phase φₚ of a metasurface element according to Embodiment I of the disclosure.

FIG. 4 is a distribution diagram of a diffractive phase φ_{DOE} of a metasurface element according to Embodiment I of the disclosure.

FIG. 5 is a distribution diagram of dot matrices projected by a metasurface element according to Embodiment I of the disclosure.

FIG. 6 is a distribution diagram of a light-homogenizing light field projected by a metasurface element according to Embodiment I of the disclosure.

FIG. 7 is an energy distribution diagram of the light-homogenizing light field in FIG. 6.

FIG. 8 is a distribution diagram of a light-homogenizing phase φ_{diffuser} of a metasurface element according to Embodiment I of the disclosure.

FIG. 9 shows responses of a nano structure of a metasurface element to phases and light transmittance rates of an s-polarized light and a p-polarized light according to Embodiment I of the disclosure.

FIG. 10 is a distribution diagram of a plurality of nano structures of a metasurface element according to Embodiment I of the disclosure.

FIG. 11 is a distribution diagram of dot matrices projected by a metasurface element according to Embodiment II of the disclosure.

FIG. 12 is a distribution diagram of a collimated phase φ_{collimator} and a phase φₚ of a metasurface element according to Embodiment II of the disclosure.

FIG. 13 is a distribution diagram of a diffractive phase φ_{DOE} of a metasurface element according to Embodiment II of the disclosure.

FIG. 14 is a distribution diagram of a light-homogenizing light field projected by a metasurface element according to Embodiment II of the disclosure.

FIG. 15 is an energy distribution diagram of the light-homogenizing light field in FIG. 14.

FIG. 16 is a distribution diagram of a light-homogenizing phase Adiffuser of a metasurface element according to Embodiment II of the disclosure.

FIG. 17 is a distribution diagram of a plurality of nano structures of a metasurface element according to Embodiment II of the disclosure.

FIG. 18 is a flowchart of a method for designing a metasurface element according to the disclosure.

The above drawings include the following reference numerals:
10. Nano structure; and 21. Light-emitting dot.

### DESCRIPTION OF EMBODIMENTS

It is to be noted that the embodiments in the present application and the features in the embodiments may be combined with one another without conflict. The disclosure will be described below in detail with reference to the drawings and the embodiments.

It is to be noted that, unless otherwise defined, all technical and scientific terms used herein have the same meaning as commonly understood by those of ordinary skill in the art to which the present application belongs.

In the disclosure, in the absence of any indication to the contrary, terms such as “on, under, top, and bottom” are used generally with respect to the orientation shown in the drawings, or with respect to the parts themselves in the vertical, perpendicular, or gravitational direction; and similarly, for ease of comprehension and description, “inside or outside” refers to the inside and the outside of the contours of the respective parts themselves, provided, however, that the above terms are not intended to be used in a manner that restricts the disclosure.

In order to solve the problem in the related art that it is difficult to integrate a plurality of projected light fields on a metasurface element, the disclosure provides a method for designing a metasurface element, and a projection device.

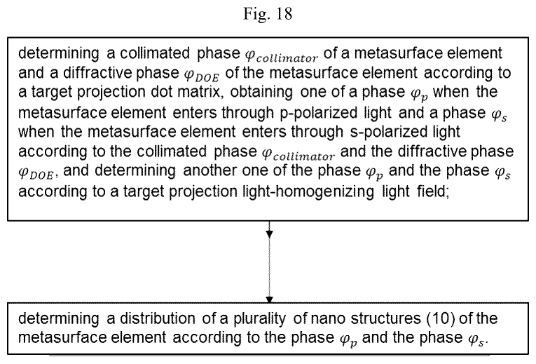

As shown in FIG. 18, the method for designing a metasurface element includes: a collimated phase φ_{collimator} of a metasurface element and a diffractive phase φ_{DOE} of the metasurface element are determined according to a target projection dot matrix, one of a phase φₚ when the metasurface element enters through p-polarized light and a phase φₛ when the metasurface element enters through s-polarized light are obtained according to the collimated phase φ_{collimator} and the diffractive phase φ_{DOE}, and the other one of the phase φₚ and the phase φₛ is determined according to a target projection light-homogenizing light field; and a distribution of a plurality of nano structures 10 of the metasurface element is determined according to the phase φₚ and the phase φₛ.

The collimated phase φ_{collimator} and the diffractive phase φ_{DOE} are determined according to the required target projection dot matrix; then one of the phase φₚ when the metasurface element enters through the p-polarized light and the phase φₛ when the metasurface element enters through the s-polarized light are obtained according to the collimated phase φ_{collimator} and the diffractive phase φ_{DOE}; the other one of the phase φₚ and the phase φₛ is determined according to the required target projection light-homogenizing light field; and finally, the distribution of the plurality of nano structures of the metasurface element is determined according to the phase φₚ and the phase φₛ, causing the distribution of the plurality of nano structures of the metasurface element to meet the phase φ_{y} and the phase φₛ at the same time, such that the metasurface element may receive the p-polarized light and the s-polarized light and project a dot matrix light field and a light-homogenizing light field, thereby realizing a projected light field in the form of a dot matrix and a projected light field of the light-homogenizing light field. By designing the metasurface element rationally, the metasurface element may realize different projected light fields for different polarized light, such that the metasurface element integrates effects of the plurality of projected light fields, thereby ensuring the diversity and scope of application of projection.

It is to be noted that, the metasurface element includes a substrate and the plurality of nano structures 10 arranged on the substrate. The distribution of the plurality of nano structures 10 meets the phase φₚ and the phase φₛ, specifically including size distribution and position distribution of the plurality of nano structures 10 all meet the phase φₚ and the phase φₛ.

It is to be further noted that, the above processes of determining the phase φₚ and the phase φₛ are not sequential, and are able to be performed at the same time. In an embodiment of the disclosure, the phase φₚ is obtained according to the collimated phase φ_{collimator} and the diffractive phase φ_{DOE}, and the phase φₛ is determined according to the required target projection light-homogenizing light field. In this case, the metasurface element receives the p-polarized light and projects a dot matrix light field, and receives the s-polarized light and projects a light-homogenizing light field. In another embodiment of the disclosure, the phase φₛ is obtained according to the collimated phase φ_{collimator} and the diffractive phase φ_{DOE}, and the phase φₚ is determined according to the required target projection light-homogenizing light field. In this case, the metasurface element receives the p-polarized light and projects the light-homogenizing light field, and receives the s-polarized light and projects the dot matrix light field. That is to say, the phase φₚ and the phase φₛ are able to be interchanged, and are able to be set according to actual situations.

In the embodiments below, description is performed based on “the phase φₚ being obtained according to the collimated phase φ_{collimator} and the diffractive phase φ_{DOE}, and the phase φₛ being determined according to the required target projection light-homogenizing light field”.

In an embodiment of the disclosure, determining the collimated phase _{collimator} of the metasurface element according to the target projection dot matrix includes: the target projection dot matrix is set to include N×N sub dot matrices, where N≥1.

$${φ}_{collimator} = \frac{2 π}{λ} {\sum }_{i = 1}^{N} {a}_{i} {r}^{2 i} + {φ}_{0} .$$

λ is a working wavelength of the metasurface element, aᵢ is a phase coefficient, r is a distance between the plurality of nano structures 10 of the metasurface element and a central position of the metasurface element, and φ₀ is a constant. Through such settings, collimated phase distribution φ_{collimator} may be obtained according to the working wavelength of the metasurface element, the phase coefficient, the distance between the plurality of nano structures 10 and the central position of the metasurface element, and the constant φ₀, facilitating the reliability of collimation.

Alternatively, in another embodiment of the disclosure, the collimated phase φ_{collimator} is expressed by using the following formula:

$${ϕ}_{collimator} = \frac{2 π}{λ} ( f - \sqrt{{r}^{2} + {f}^{2}} ) + {φ}_{0} .$$

λ is a working wavelength of the metasurface element, r is a distance between the plurality of nano structures 10 of the metasurface element and a central position of the metasurface element, φ₀ is a constant, and f is a working focal length of the metasurface element, that is, a distance between the metasurface element and a light source. The collimated phase φ_{collimator} of the disclosure is able to be calculated by the above two formulas, thereby ensuring a collimation effect.

In an embodiment, when

$${ϕ}_{collimator} = \frac{2 π}{λ} ( f - \sqrt{{r}^{2} + {f}^{2}} ) + {φ}_{0} ,$$

the working focal length f of the metasurface element meets:

$$f = \sqrt{\frac{{{W}^{2} ( N - 1 )}^{2}}{16 sin \frac{FOI}{2}} - \frac{{W}^{2}}{4}} .$$

W is a size of a light source chip, and FOI is a field of illumination of the target projection dot matrix. Through such settings, the working focal length f of the metasurface element may be rationally calculated according to the size of the light source chip, the field of illumination FOI, and the number N of the sub dot matrices, such that the working focal length f of the metasurface element matches the collimated phase φ_{collimator}, and the calculation accuracy of the collimated phase is ensured, thereby ensuring a collimation effect of a dot matrix light field projected finally. It is to be noted that, the W includes the size of the light source chip in a first direction and the size of the light source chip in a second direction; the first direction is perpendicular to the second direction; and generally, the size of the light source chip in the first direction is equal to the size of the light source chip in the second direction. The field of illumination FOI of the target projection dot matrix is greater than or equal to 60°×50° and less than or equal to 90°×70°. In an embodiment of the disclosure, the field of illumination FOI of the target projection dot matrix is 60°×60°, 80°×60°, or other combinations, which is determined together by the size W of the light source chip, the working focal length f of the metasurface element, and the number N of the sub dot matrices, and is converted and expressed as:

$$sin ( \frac{FOI}{2} ) = \frac{W ( N - 1 )}{2 \sqrt{{W}^{2} + 4 {f}^{2}}} .$$

It is to be further noted that, in an embodiment, the target projection dot matrix is set to include a 1×1 sub dot matrix, which is configured as a collimator lens; alternatively, in another embodiment, the target projection dot matrix also is able to be set to include 3×3 sub dot matrices, 5×5 sub dot matrices, etc. N≥1 and Nis an odd number, and through such setting, the implementability and projection stability of a projected dot matrix.

It is to be further noted that, the light source chip is a VCSEL light source chip. The VCSEL light source chip is a light source for projecting a dot matrix light field and a light-homogenizing light field. The VCSEL light source chip is able to emit light in different polarization states, and is able to switch the polarization state of an output light field, such as the s-polarized light and the p-polarized light.

In an embodiment, determining the diffractive phase φ_{DOE} of the metasurface element according to the target projection dot matrix includes: the diffractive phase φ_{DOE} of the metasurface element is generated by using an iterative Fourier algorithm, which is a G-S algorithm, according to the target projection dot matrix. Through such settings, the accuracy of the diffractive phase φ_{DOE} is guaranteed, and a replication effect of the diffractive phase φ_{DOE} to the dot matrix of the light source is guaranteed.

In an embodiment, after the diffractive phase φ_{DOE} and the collimated phase φ_{collimator} are obtained, obtaining one of the phase φₚ when the metasurface element enters through the p-polarized light and the phase φₛ when the metasurface element enters through the s-polarized light according to the collimated phase φ_{collimator} and the diffractive phase φ_{DOE} includes: the phase φₚ is obtained according to the collimated phase φ_{collimator} and the diffractive phase φ_{DOE}, where φₚ=mod(φ_{collimator}+φ_{DOE},2π), and mod is a remainder obtaining function. Through such settings, the metasurface element meeting the phase φₚ may receive the P-polarized light, and collimate and replicate the P-polarized light, so as to output the dot matrix light field.

In an embodiment, a light-homogenizing phase φ_{diffuser} of the metasurface element is generated by using the iterative Fourier algorithm, which is the G-S algorithm, according to the target projection light-homogenizing light field. The light-homogenizing phase φ_{diffuser} is configured to uniformly project approximately Gaussian-distributed light emitted by the light source to a far-field position; and the other one of the phase φₛ when the metasurface element enters through the s-polarized light and the phase φₚ when the metasurface element enters through the p-polarized light is obtained by using the remainder obtaining function according to the light-homogenizing phase φ_{diffuser}, and in an embodiment of the disclosure, the phase φₛ is obtained, where φₛ=mod(φ_{diffuser},2π). Through such settings, the metasurface element meeting the phase φₛ may receive the s-polarized light, and perform quasi light homogenizing and diffusion on the s-polarized light, so as to output the light-homogenizing light field.

In an embodiment, before and in the process of determining the distribution of the plurality of nano structures 10 of the metasurface element according to the phase φₚ and the phase ₛ, the method for designing a metasurface element further includes: a relationship diagram between a size of an initial nano structure and a phase of the initial nano structure is established, and distribution of a plurality of initial nano structures meeting the phase φₚ and the phase φₛ is searched from the relationship diagram, such that the distribution of the plurality of initial nano structures serves as the distribution of the plurality of nano structures 10 of the metasurface element that is finally designed. That is to say, the size distribution and arrangement position distribution of the plurality of initial nano structures that meet the phase φₚ and the phase φₛ at the same time are searched from the relationship diagram, so as to obtain the distribution of the plurality of nano structures 10 of the final metasurface element, thereby completing the design of the metasurface element.

It is to be noted that, the relationship diagram is a relationship diagram between the size and the phase of the initial nano structure in two directions. The two directions are two direction that are perpendicular to each other. When a shape of the initial nano structure is an elliptical cylinder, the two directions are a long axis direction and a short axis direction of the initial nano structure. When the shape of the initial nano structure is a cuboid, the two directions are a length direction and a width direction of the cuboid.

In an embodiment, searching the distribution of the plurality of initial nano structures meeting the phase φₚ and the phase φₛ from the relationship diagram includes: the initial nano structures included in the relationship diagram are traversed, absolute values of errors between the phase of the initial nano structure in the relationship diagram and the phase φₚ, and between the phase of the initial nano structure in the relationship diagram and the phase φₛ are calculated, and the initial nano structure in which the absolute values of the errors meet a preset error and a light transmittance rate is greater than or equal to a preset light transmittance rate is selected. The preset error is specifically a minimum error, that is, an initial nano structure with the minimum error is selected. The preset light transmittance rate is greater than 80% and less than or equal to 100%. It is to be noted that, the absolute values of the errors are specifically absolute values of phase errors, including an absolute value of a first error between the phase of the initial nano structure and the phase φₚ, and an absolute value of a second error between the phase of the initial nano structure and the phase φₛ. The initial nano structure of which the absolute value of the first error and the absolute value of the second error both are minimum and the light transmittance rate is greater than or equal to the preset light transmittance rate is selected, so as to obtain the distribution of the plurality of initial nano structures that meets the phase φₚ and the phase φₛ at the same time.

In an embodiment, establishing the relationship diagram between the size of the initial nano structure and the phase of the initial nano structure includes: the shape of the initial nano structure is preset; the initial nano structures with different sizes are scanned according to the shape of the initial nano structure, so as to obtain phase responses of the initial nano structures with the same shapes and different sizes to the s-polarized light and the p-polarized light; and the relationship diagram between the size of the initial nano structure and the phase of the initial nano structure is established. In an embodiment, the shape of the initial nano structure is selected first, and after the shape is determined, the phases of the initial nano structures with the same shapes and different sizes to the s-polarized light and the p-polarized light are scanned. The sizes include the sizes of the nano structures 10 in the two directions perpendicular to each other, such that the phase responses of the initial nano structures with the same shapes and different sizes to the s-polarized light and the p-polarized light are obtained, thereby further establishing the relationship diagram between the size and phase of the initial nano structure.

In an embodiment, in the process of presetting the shape of the initial nano structure, the shape of the initial nano structure is of a columnar non-rotationally symmetric structure such that the initial nano structure is an anisotropic structure. Furthermore, a cross section of the initial nano structure in a direction parallel to the substrate is an oval or a polygon. The polygon includes a quadrilateral, a hexagon, etc. In an embodiment, the polygon is the quadrilateral, and in another embodiment, the polygon is a rectangle. In an embodiment of the disclosure, the initial nano structure is able to be designed as the anisotropic structure such as a cuboid, an elliptical cylinder, etc. The initial nano structure may not be a cylindrical isotropic structure. The isotropic structure may not meet a requirement of generating polarization dependence in the disclosure. By rationally planning and presetting the shape of the initial nano structure, it ensures that the shape of the initial nano structure meets a requirement for polarization characteristics, thereby ensuring an effect of controlling the light in different polarization states.

In an embodiment, before or after presetting the shape of the initial nano structure includes: a material of the initial nano structure is preset according to the working wavelength of the metasurface element. The material of the initial nano structure includes one of Si, aSi, iO₂, GaN, and HfO₂. In an embodiment of the disclosure, before the shape of the initial nano structure is preset, the material of the initial nano structure is selected according to the working wavelength of the metasurface element. In an embodiment of the disclosure, the working wavelength of the metasurface element is 940 nm, such that the aSi is selected as the material of the initial nano structure. After the material of the initial nano structure is determined, the shape of the initial nano structure is then preset. By rationally designing a material of the nano structure 10, a light transmittance rate of the nano structure 10 is ensured. The light transmittance rate of the nano structure 10 is ensured to be above 80%, thereby ensuring light transmission efficiency, thus avoiding waste of light.

In an embodiment, before or after the shape of the initial nano structure is preset, or in the process of scanning the phases of the initial nano structures with the same shapes and different sizes, a height of the nano structure 10 is set to be within a range greater than or equal to 400 nm and less than or equal to 800 nm, in an embodiment, the heights of the plurality of nano structures 10 are the same. The optimal height of the nano structure 10 is able to be determined through scanning. That is to say, in the process of scanning the phase of the initial nano structure, the optimal height is able to be determined by scanning the heights of the nano structures 10.

In an embodiment, in the process of scanning the phases of the initial nano structures with the same shapes and different sizes, a distance between the adjacent nano structures 10 among the plurality of nano structures 10 is preset to be greater than or equal to 100 nm and less than or equal to 700 nm. By rationally planning the distance between the adjacent nano structures 10, a distribution density and positions of the nano structures 10 are planned, facilitating the matching between the phases of the plurality of final nano structures 10 and the phase φₚ and the phase φₛ. In different embodiments of the disclosure, the distance between the adjacent nano structures 10 is 300 nm, 400 nm, or 500 nm.

It is to be noted that, the field of view of the target projection light-homogenizing light field is greater than or equal to 100°×60° and less than or equal to 130°×60°. In different embodiments of the disclosure, the field of view of the target projection light-homogenizing light field may be 100°×60°, 130°×60°, or a larger field of view. By rationally controlling the shapes, sizes, and positions of the plurality of nano structures 10 on the substrate of the metasurface element, the distribution of the plurality of nano structures 10 meets the phase φₚ and the phase φₛ at the same time, such that the field of view of the light-homogenizing light field outputted by the metasurface element may be effectively increased, thereby ensuring a large field of view.

The method for designing a metasurface element of the disclosure is described below with reference to specific embodiments.

### Embodiment I

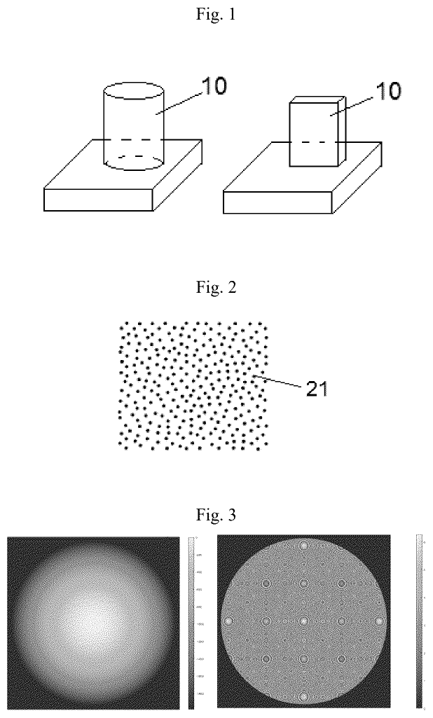

As shown in FIG. 1 to FIG. 10, a process of designing a metasurface element in Embodiment I is described.

In this embodiment, a target projection dot matrix includes 3×3 sub dot matrices, and a field of view of a target projection light-homogenizing light field is 1000×60°. When p-polarized light enters a metasurface element, 3×3 replicated dot matrices are projected in a far field, and the field of view is 60°× 50°. When s-polarized light enters the metasurface element, a homogeneous light field with a field of view being 100°×60° is projected in the far field.

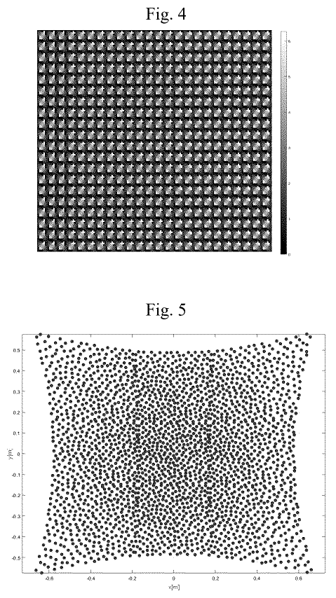

In this embodiment, a working wavelength of the metasurface element is 940 nm; a light source is a VCSEL light source, which is an array VCSEL; and a size of the light source is 422 um×364 um. The light source includes a plurality of light-emitting dots 21, which includes 275 light-emitting dots 21. The 275 light-emitting dots 21 form one dot matrix, as shown in FIG. 2. A working focal length f of the metasurface element is determined to be 1.25 mm, the working focal length is a focal length of the collimated phase φ_{collimator}; through calculation, the collimated phase φ_{collimator} is obtained; and collimated phase distribution is shown in a left-side picture in FIG. 3. Then a diffractive phase φ_{DOE} is determined; distribution of the diffractive phase φ_{DOE} is shown in FIG. 4; and the diffractive phase φ_{DOE} is configured to replicate the dot matrix of the light source to generate the 3×3 sub dot matrices. The diffractive phase φ_{DOE} and the collimated phase φ_{collimator} are combined as φₚ by using a remainder obtaining function, and combined phase distribution is shown in a right-side picture in FIG. 3.

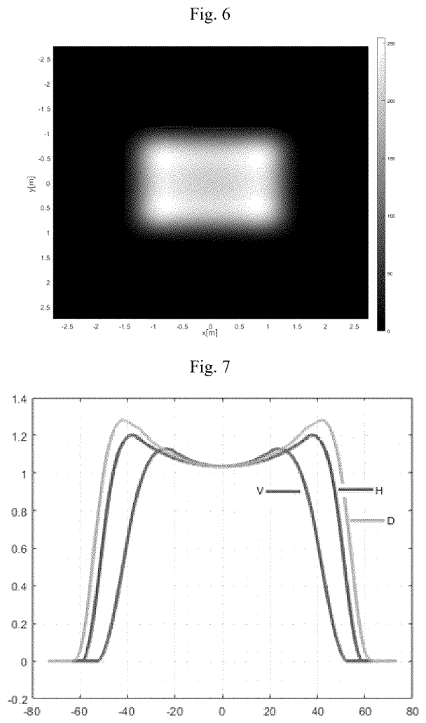

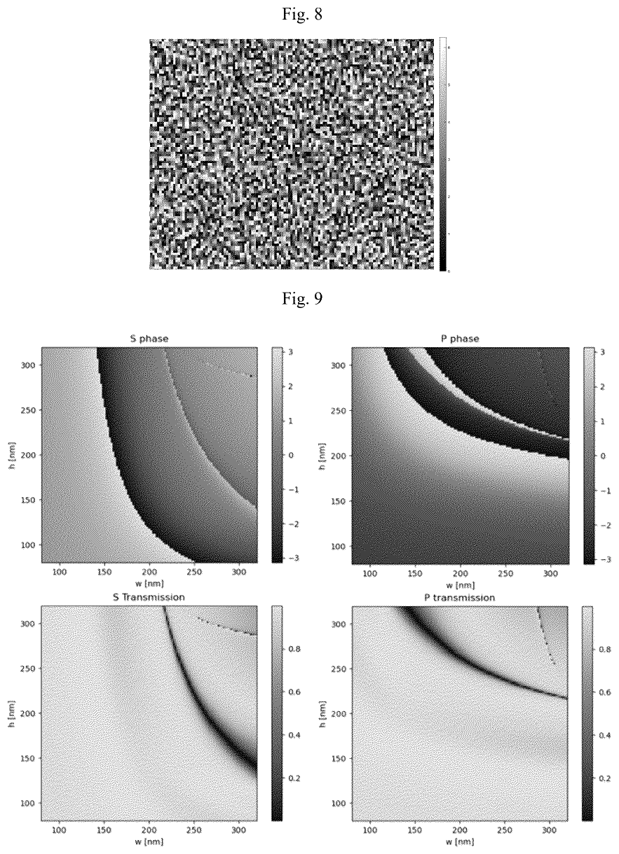

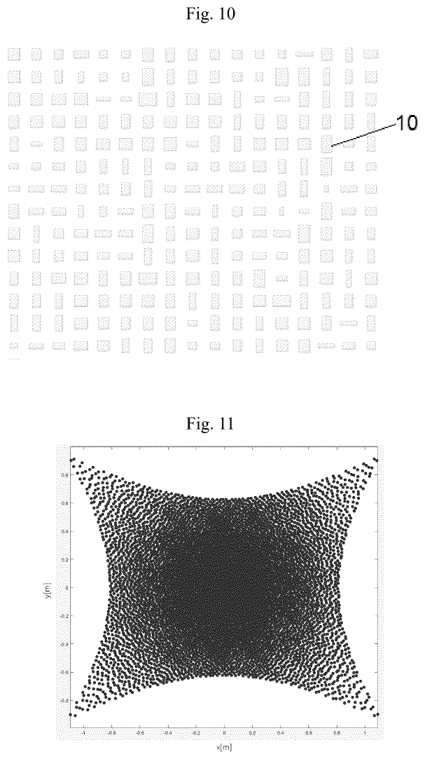

In an embodiment, a light-homogenizing phase φ_{diffuser} required is calculated by using a G-S algorithm, and distribution is shown in FIG. 8; and the light-homogenizing phase φ_{diffuser} is converted into φₛ. Then a shape of a nano structure 10 is set to a cuboid, referring to a right-side picture in FIG. 1. Then a size of the nano structure 10 is scanned to obtain phase responses of the nano structures 10 with the same shapes, different lengths and different widths are obtained, as shown in FIG. 9. A relationship diagram between a size and a phase is established; then the plurality of nano structures 10 with appropriate lengths and widths are selected from the relationship diagram, causing the nano structures to meet a relatively-high light transmittance rate and simultaneously meet a phase distribution requirement of φₚ and φₛ; then distribution of the plurality of nano structures 10 of the disclosure is generated; and the distribution of the plurality of nano structures 10 finally obtained is shown in FIG. 10. From FIG. 10, it is seen that, a projection of each of the plurality nano structures 10 on a substrate is a quadrilateral, that is, a shape of a cross section of each of the plurality nano structures 10 in a direction parallel to the substrate is a quadrilateral, and lengths and widths of at least partial nano structures 10 are different. The plurality of nano structures 10 are arranged in an array. Distribution of the dot matrices finally projected at a distance of 1 m is shown in FIG. 5. Light field distribution of a homogeneous light field is shown in FIG. 6, and edge energy is appropriately increased to compensate for reduction in relative illumination when receiving a large field of view of a camera. An energy distribution curve of the homogeneous light field in horizontal H, vertical V, and diagonal D directions is shown in FIG. 7.

### Embodiment II

As shown in FIGS. 11-17, a process of designing a metasurface element in Embodiment II is described.

In this embodiment, a target projection dot matrix includes 5×5 sub dot matrices, and a field of view of a target projection light-homogenizing light field is 130°×80°. When p-polarized light enters a metasurface element, 5×5 replicated dot matrices are projected in a far field, and the field of view is 78°×64°. When s-polarized light enters the metasurface element, a homogeneous light field with a field of view being 130°×80° is projected in the far field.

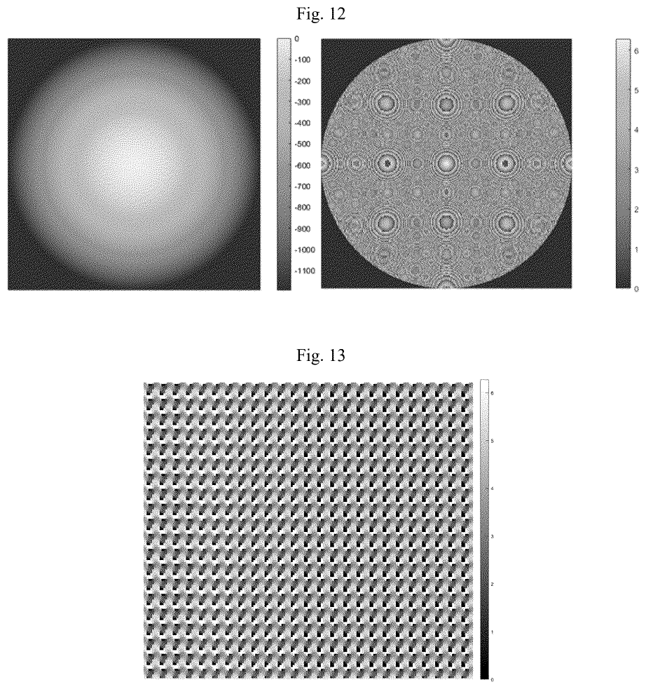

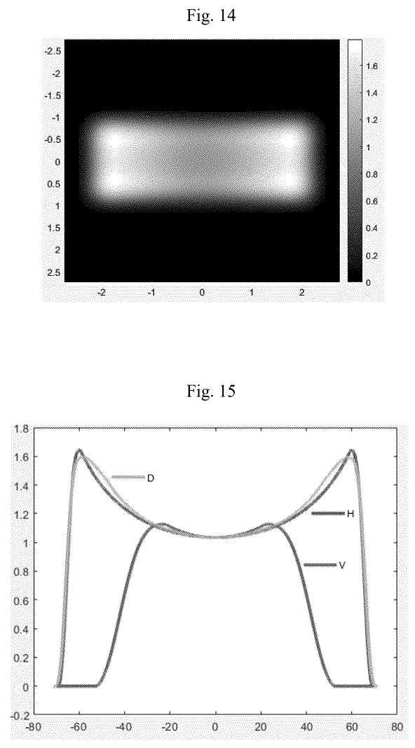

In this embodiment, a working wavelength of the metasurface element is 940 nm; a light source is a VCSEL light source, which is an array VCSEL; and a size of the light source is 422 um×364 um. The light source includes a plurality of light-emitting dots 21, which includes 275 light-emitting dots 21. The 275 light-emitting dots 21 form one dot matrix, referring to FIG. 2. A working focal length f of the metasurface element is determined to be 1.70 mm, the working focal length is a focal length of the collimated phase φ_{collimator}; through calculation, the collimated phase φ_{collimator} is obtained; and collimated phase distribution is shown in a left-side picture in FIG. 12. Then a diffractive phase φ_{DOE} is determined; distribution of the diffractive phase φ_{DOE} is shown in FIG. 13; and the diffractive phase φ_{DOE} is configured to replicate the dot matrix of the light source to generate the 5×5 sub dot matrices. The diffractive phase φ_{DOE} and the collimated phase φ_{collimator} are combined as φₚ by using a remainder obtaining function, and combined phase distribution is shown in a right-side picture in FIG. 12.

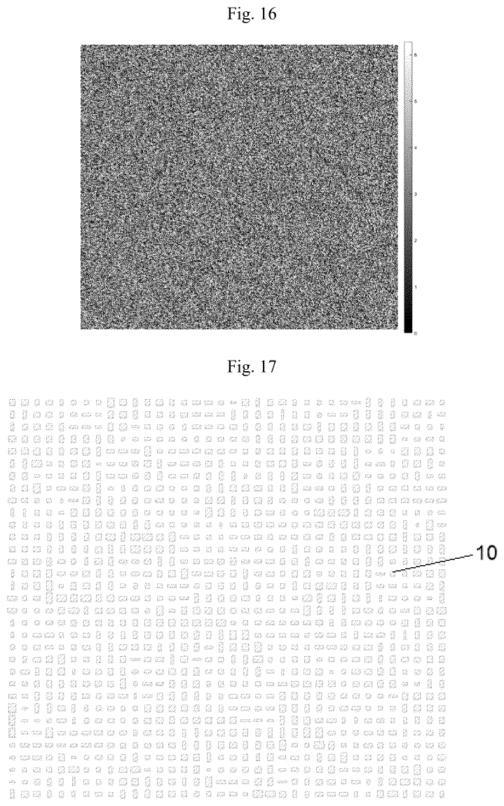

In an embodiment, a light-homogenizing phase φ_{diffuser} required is calculated by using a G-S algorithm, and distribution is shown in FIG. 16. From the figure, it may be learned that, compared to Embodiment I, changes in the light-homogenizing phase in this embodiment are more violently, and the light-homogenizing phase φ_{diffuser} is converted into φₛ. Then a shape of a nano structure 10 is set to a cuboid, referring to a right-side picture in FIG. 1, which is the same as Embodiment I. Then a size of the nano structure 10 is scanned to obtain phase responses of the nano structures 10 with the same shapes, different lengths and different widths are obtained, referring to FIG. 9. A relationship diagram between a size and a phase is established; then the plurality of nano structures 10 with appropriate lengths and widths are selected from the relationship diagram, causing the nano structures to meet a relatively-high light transmittance rate (greater than 80%) and simultaneously meet a phase distribution requirement of φₚ and φₛ; then distribution of the plurality of nano structures 10 of the disclosure is generated; and the distribution of the plurality of nano structures 10 finally obtained is shown in FIG. 17. From FIG. 17, it is seen that, a projection of each of the plurality of nano structures 10 on a substrate is a quadrilateral, that is, a shape of a cross section of each of the plurality of nano structures 10 in a direction parallel to the substrate is a quadrilateral, and lengths and widths of at least partial nano structures 10 are different. The plurality of nano structures 10 are arranged in an array. Distribution of the dot matrices finally projected at a distance of 1 m is shown in FIG. 11. Light field distribution of a homogeneous light field is shown in FIG. 14, and edge energy is appropriately increased to compensate for reduction in relative illumination when receiving a large field of view of a camera. An energy distribution curve of the homogeneous light field in horizontal H, vertical V, and diagonal D directions is shown in FIG. 15.

To sum up, in this method, the phase control capability of the metasurface element may be used to integrate the collimated phase and the diffractive phase together, so as to improve the integration of the metasurface element, thereby reducing costs. Compared to a homogeneous light field projected by a traditional microlens, the homogeneous light field projected in the disclosure has a larger field of view. Since a slope of an edge of a surface shape of the corresponding microlens is large when a target field of view of the traditional microlens is large, resulting in difficult processing, a larger field of view may be realized by using high sampling accuracy of the metasurface element in the disclosure. Furthermore, in the disclosure, the dot matrix or homogeneous light field may be projected in the far field by using polarization control, so as to realize the integration of two projection functions, thereby greatly increasing function integration, and expanding the scope of application.

The disclosure further provides a projection device, including a light source and a metasurface element. The light source is configured to emit light in different polarization states. The light source includes a plurality of light-emitting dots 21. The metasurface element is obtained by the method for designing a metasurface element. That is to say, the metasurface element in the projection device of the disclosure is the same as the metasurface element in the above method. Limitations to the structure and parameter of the metasurface element are able to be referred to the description in the above method, and are not described herein again. The metasurface element includes a substrate and a plurality of nano structures 10 arranged on the substrate. The nano structures 10 are columnar non-rotationally symmetric structures. A phase of the metasurface element includes various functional phases such that the metasurface element projects a dot matrix to the light in one polarization state and projects a light field to the light in the other polarization state.

By rationally planning the shape of the nano structure 10 to be the columnar non-rotationally symmetric structure, the nano structure 10 is an anisotropic structure, such that the nano structure 10 may generate polarization related characteristics, and thus may respond to different types of polarized light. The phase of the metasurface element includes various functional phases, such that the metasurface element may receive the p-polarized light and project a dot matrix, so as to realize a projected light field in the form of the dot matrix, the metasurface element may also receive the s-polarized light and project a light-homogenizing light field, so as to realize a projected light field of the light-homogenizing light field. Therefore, the metasurface element may realize different projected light fields for different polarized light, causing the metasurface element to integrate an effect of various projected light fields, thereby ensuring the diversity and scope of application of projection.

In an embodiment, the light source in the above method and the light source in the projection device both are VCSEL light sources. The VCSEL light source is configured to provide and emit light in different polarization states, and the polarization state of an output light field is able to be switched according to requirements, for example, the s-polarized light and the p-polarized light. In an embodiment, the plurality of nano structures 10 is arranged in an array. In an embodiment, the plurality of nano structures 10 are arranged in both directions that are perpendicular to each other. In an embodiment of the disclosure, the plurality of nano structures 10 are arranged in a square array, a regular hexagonal array, in a fan-shaped dense arrangement, etc., which may be selected according to specific requirements. Through such settings, by rationally planning the arrangement mode of the plurality of nano structures 10, it ensures that the phases of the plurality of nano structures 10 meet various functional phases, thereby ensuring that the metasurface element may project various light fields.

In an embodiment, cross sections of the plurality of nano structures 10 in a direction parallel to the substrate include one or more of an oval or a polygon. When the cross sections of the plurality of nano structures 10 in the direction parallel to the substrate include the polygon, the polygon includes a quadrilateral and a hexagon, in an embodiment, the polygon is the quadrilateral, and in another embodiment, the polygon is a rectangle. In an embodiment of the disclosure, the cross sections of all the nano structures 10 in the direction parallel to the substrate are ovals. In another embodiment of the disclosure, the cross sections of all the nano structures 10 in the direction parallel to the substrate are polygons. In the embodiments shown in FIG. 10 and FIG. 17, the nano structures 10 are cuboids, that is, the cross sections of the nano structures 10 in the direction parallel to the substrate are all rectangles. By rationally planning and presetting the shape of the initial nano structure, it ensures that the shape of the initial nano structure meets a requirement for polarization characteristics, thereby ensuring an effect of controlling the light in different polarization states.

As shown in FIG. 10 and FIG. 17, projections of the nano structures 10 on the substrate have the same shape, and sizes of at least partial nano structures 10 are different in the two directions, that is to say, projections of which of the nano structures 10 on the substrate are the same, and sizes of projected figures are different. In an embodiment, the sizes of at least partial projected figures in the two directions perpendicular to each other are different. For example, when the shapes of the projections of the nano structures 10 on the substrates are rectangles, the rectangles of the projections of at least partial nano structures 10 on the substrates have different lengths, and the rectangles of the projections of at least partial nano structures 10 on the substrates have different widths. When the shapes of the projections of the nano structures 10 on the substrates are all ovals, the ovals of the projections of at least partial nano structures 10 on the substrates have different long axis lengths, and the ovals of the projections of at least partial nano structures 10 on the substrates have different short axis lengths.

In the disclosure, the various functional phases include the phase φₚ when the metasurface element enters through the p-polarized light and the phase φₛ when the metasurface element enters through the s-polarized light. The phase φₛ is composed of a light-homogenizing phase φ_{diffuser}, such that the metasurface element meeting the phase φₛ may receive the s-polarized light, and perform quasi light homogenizing and diffusion on the s-polarized light, so as to output the light-homogenizing light field. The phase φₚ is composed of a diffractive phase φ_{DOE} and a collimated phase φ_{collimator}, such that the metasurface element meeting the phase φₚ may receive the p-polarized light, and collimate and replicate the p-polarized light, so as to output the dot matrix light field.

In an embodiment, φₛ=mod(φ_{diffuser},2π), φₚ=mod(φ_{collimator}+φ_{DOE},2π). φ_{collimator} is the collimated phase, which is configured to collimate divergent light of a light source; φ_{DOE} is the diffractive phase, which is configured to replicate a dot matrix; and φ_{diffuser} is the light-homogenizing phase, which is configured to uniformly project approximately Gaussian-distributed light emitted by the light source to a far field. φₚ and φₛ are interchangeable, and mod is a remainder obtaining function.

In an embodiment, one polarized light projects N×N sub dot matrices by passing through the metasurface element, where N≥1; and the number of dots in the single dot matrix is equal to the number of the plurality of light-emitting dots 21 of the light source, where N is an odd number. When a 1×1 sub dot matrix is projected, the metasurface element is configured as a collimator lens, and in this case, the number of dots in the dot matrix projected by the metasurface element is the same as the number of the light-emitting dots 21 of the light source. Definitely, 3×3 sub dot matrices, 5×5 sub dot matrices, and the like may also be projected, but N needs to be an odd number. Through such settings, the implementability and projection stability of a projected dot matrix is ensured.

In an embodiment, the p-polarized light emitted by the light source projects a dot matrix light field after passing through the metasurface element. A field of view of the dot matrix is greater than or equal to 60°× 50° and less than or equal to 90°×70°. In an embodiment of the disclosure, the field of view of the dot matrix is 60°×60°, 80°×60°, or other combinations. The s-polarized light emitted by the light source projects a light-homogenizing light field after passing through the metasurface element. A field of view of the light-homogenizing light field is greater than or equal to 100°×60° and less than or equal to 130°×60°. In different embodiments of the disclosure, the field of view of a target projection light-homogenizing light field is 100°×60°, 130°×60°, or a larger field of view. Through such settings, it ensures that the output light field has the advantage of a large field of view, facilitating an increase in a projection coverage, thereby ensuring a projection effect.

In an embodiment, a distance between the adjacent two nano structures 10 among the plurality of nano structures 10 is greater than or equal to 100 nm and less than or equal to 700 nm; and heights of the nano structures 10 are greater than or equal to 400 nm and less than or equal to 800 nm. In an embodiment of the disclosure, the heights of all the nano structures 10 are the same. By rationally planning the distance between the adjacent nano structures 10, a distribution density and positions of the nano structures 10 are planned, facilitating the matching between the phases of the plurality of final nano structures 10 and the phase φₚ and the phase φₛ. In different embodiments of the disclosure, the distance between the adjacent nano structures 10 is 300 nm, 400 nm, or 500 nm.

In an embodiment, the projection device further includes a film structure, and the film structure is located on a surface of the substrate that is provided with the nano structures 10. The film structure is an adhesive layer or a SiO₂ layer. Through the arrangement of the film structure, the nano structures 10 are protected by the film structure, facilitating improvement of the stability of the nano structures 10. In one embodiment of the disclosure, the film structure covers the surface of a side of the substrate that is provided with the nano structures 10 by following the shape, such that top surfaces and side walls of the nano structures 10 are covered. In another embodiment of the disclosure, the film structure is filled in the surface of the side of the substrate that is provided with the nano structures 10. While ensuring the top surfaces and side walls of the nano structures 10 are covered, a gap between the adjacent nano structures 10 is also filled by the film structure, causing the metasurface element to be integrally formed, thereby ensuring the use reliability and stability of the entire metasurface element.

It may be seen from the above description that, in the above embodiments of the disclosure, the following technical effects are realized.

1. A size of the projection device is reduced, such that the projection of various light fields may be realized by only using one metasurface element.

2. A homogeneous light field with a large field of view may be obtained by using the metasurface element of the disclosure, and the field of view may reach above 120°.

3. In the disclosure, by controlling the light source to emit the light in different polarization states, the dot matrix or light-homogenizing light field is projected in the far field.

It is apparent that the described embodiments are only part of the embodiments of the disclosure, not all the embodiments. Based on the embodiments in the disclosure, all other embodiments obtained by those of ordinary skill in the art without creative work shall fall within the protection scope of the disclosure.

It is to be noted that, terms used herein are intended to describe specific implementations only and are not intended to limit exemplary embodiments according to the disclosure. As used herein, unless the context clearly indicates otherwise, a singular form is also intended to include a plural form. In addition, it is further understood that when the terms “including” and/or “comprising” are used in this specification, the terms indicate the presence of features, steps, operations, devices, components, and/or a combination thereof.

It is to be noted that terms “first”, “second” and the like in the description, claims and the above mentioned drawings of the disclosure are used for distinguishing similar objects rather than describing a specified sequence or a precedence order. It should be understood that the data used in such a way may be exchanged where appropriate, in order that the implementations of the disclosure described here may be implemented in an order other than those illustrated or described herein.

The above are only the preferred embodiments of the disclosure and are not intended to limit the disclosure. For those skilled in the art, the disclosure may have various modifications and variations. Any modifications, equivalent replacements, improvements and the like made within the spirit and principle of the disclosure all fall within the scope of protection of the disclosure.

What is claimed is:

1. A method for designing a metasurface element, comprising:
determining a collimated phase φ_{collimator} of a metasurface element and a diffractive phase φ_{DOE} of the metasurface element according to a target projection dot matrix, obtaining one of a phase φₚ when the metasurface element enters through p-polarized light and a phase φₛ when the metasurface element enters through s-polarized light according to the collimated phase φ_{collimator} and the diffractive phase φ_{DOE}, and determining another one of the phase φₚ and the phase φₛ according to a target projection light-homogenizing light field; and
determining a distribution of a plurality of nano structures of the metasurface element according to the phase φₚ and the phase φₛ.

2. The method for designing a metasurface element according to claim 1, wherein determining the collimated phase φ_{collimator} of the metasurface element according to the target projection dot matrix comprises: setting the target projection dot matrix to comprise N×N sub dot matrices, wherein N≥1,
$${φ}_{collimator} = \frac{2 π}{λ} {\sum }_{i = 1}^{N} {a}_{i} {r}^{2 i} + {φ}_{0} ;$$
λ is a working wavelength of the metasurface element, αᵢ is a phase coefficient, r is a distance between the plurality of nano structures of the metasurface element and a central position of the metasurface element, and φ₀ is a constant.

3. The method for designing a metasurface element according to claim 1, wherein determining the collimated phase collimator of the metasurface element according to the target projection dot matrix comprises: setting the target projection dot matrix to comprise N×N sub dot matrices, wherein N≥1,
$${φ}_{collimator} = \frac{2 π}{λ} ( f - \sqrt{{r}^{2} + {f}^{2}} ) + {φ}_{0} ;$$
λ is an working wavelength of the metasurface element, r is a distance between the plurality of nano structures of the metasurface element and a central position of the metasurface element, φ₀ is a constant, and f is a working focal length of the metasurface element.

4. The method for designing a metasurface element according to claim 3, wherein the working focal length f of the metasurface element meets:
$$f = \sqrt{\frac{{{W}^{2} ( N - 1 )}^{2}}{16 sin \frac{FOI}{2}} - \frac{{W}^{2}}{4}} ;$$
wherein W is a size of a light source chip, and FOI is a field of illumination of the target projection dot matrix.

5. The method for designing a metasurface element according to claim 1, wherein determining the diffractive phase φ_{DOE} of the metasurface element according to the target projection dot matrix comprises:
generating the diffractive phase φ_{DOE} of the metasurface element by using an iterative Fourier algorithm according to the target projection dot matrix.

6. The method for designing a metasurface element according to claim 1, wherein obtaining one of the phase φₚ when the metasurface element enters through the p-polarized light and the phase φₛ when the metasurface element enters through the s-polarized light according to the collimated phase φ_{collimator} and the diffractive phase φ_{DOE} comprises: obtaining the phase φₚ according to the collimated phase φ_{collimator} and the diffractive phase φ_{DOE}, wherein
$${φ}_{p} = mod ( {ϕ}_{collimator} + {φ}_{DOE} , 2 π ) .$$

7. The method for designing a metasurface element according to claim 1, wherein determining another one of the phase φₚ and the phase φₛ according to the target projection light-homogenizing light field comprises:
generating a light-homogenizing phase φ_{diffuser} of the metasurface element by using an iterative Fourier algorithm according to the target projection light-homogenizing light field, and according to the light-homogenizing phase φ_{diffuser}, obtaining the phase φₛ when the metasurface element enters through the s-polarized light, wherein φₛ=mod(φ_{diffuser},2π).

8. The method for designing a metasurface element according to claim 1, wherein before determining the distribution of the plurality of nano structures of the metasurface element according to the phase φₚ and the phase φₛ, the method for designing a metasurface element further comprises:
establishing a relationship diagram between a size of an initial nano structure and a phase of the initial nano structure, and searching distribution of a plurality of initial nano structures meeting the phase φₚ and the phase φₛ from the relationship diagram.

9. The method for designing a metasurface element according to claim 8, wherein searching the distribution of the plurality of initial nano structures meeting the phase φₚ and the phase φₛ from the relationship diagram comprises:
calculating absolute values of errors between the phase of the initial nano structure in the relationship diagram and the phase φₚ, and between the phase of the initial nano structure in the relationship diagram and the phase φₛ, and selecting the initial nano structure in which the absolute values of the errors meet a preset error and a light transmittance rate is greater than or equal to a preset light transmittance rate.

10. A projection device, comprising:
a light source, configured to emit light in different polarization states, wherein the light source comprises a plurality of light-emitting dots; and
a metasurface element, obtained by the method for designing a metasurface element according to claim 1, wherein the metasurface element comprises a substrate and a plurality of nano structures arranged on the substrate, the plurality of nano structures are columnar non-rotationally symmetric structures, a phase of the metasurface element comprises various functional phases such that the metasurface element projects a dot matrix to lights in one polarization state and projects a light-homogenizing light field to lights in another polarization state.

11. The method for designing a metasurface element according to claim 8, wherein establishing the relationship diagram between the size of an initial nano structure and the phase of the initial nano structure comprises:
a shape of the initial nano structure is preset; initial nano structures with different sizes are smayned according to the shape of the initial nano structure, so as to obtain phase responses of initial nano structures with a same shape and different sizes to the s-polarized light and the p-polarized light; and the relationship diagram between the size of the initial nano structure and the phase of the initial nano structure is established.

12. The method for designing a metasurface element according to claim 11, wherein presetting the shape of the initial nano structure comprises:
the initial nano structure is designed as a columnar non-rotationally symmetric structure, and a cross section of the initial nano structure in a direction parallel to a substrate is an oval or a polygon.

13. The method for designing a metasurface element according to claim 11, wherein before or after presetting the shape of the initial nano structure comprises:
a material of the initial nano structure is determined according to a working wavelength of the metasurface element, wherein the material of the initial nano structure comprises one of Si, aSi, TiO₂, GaN, and HfO₂.

14. The method for designing a metasurface element according to claim 11, wherein
a height of the nano structure is set to be within a range greater than or equal to 400 nm and less than or equal to 800 nm; and/or
a distance between adjacent nano structures among the plurality of nano structures is set to be greater than or equal to 100 nm and less than or equal to 700 nm; and/or
the plurality of nano structures are arranged in an array.

15. The projection device according to claim 10, wherein the projection device further comprises a film structure, and the film structure is located on a surface of the substrate that is provided with the plurality of nano structures.

16. The projection device according to claim 15, wherein the film structure isomorphically covers a surface of a side of the substrate that is provided with the plurality of nano structures, such that top surfaces and side walls of the plurality of nano structures are covered.

17. The projection device according to claim 15, wherein the film structure is filled in the surface of a side of the substrate that is provided with the plurality of nano structures, a gap between adjacent nano structures of the plurality of nano structures is also filled by the film structure.
